(19) United States
(12) Patent Application Publication
(10) Pub. No.: US 2008/0219668 A1
(43) Pub. Date: Sep. 11, 2008

(54) LIQUID CRYSTAL OPTICAL DEVICE WITH ARRAYED WAVEGUIDE GRATING

(76) Inventor: Giovanni Barbarossa, Saratoga, CA (US)

Correspondence Address: PATTERSON & SHERIDAN, LLP, 3040 POST OAK BLVD, SUITE 1500, HOUSTON, TX, 77056, US

(21) Appl. No.: 12/032,224

(22) Filed: Feb. 15, 2008

Related U.S. Application Data
(60) Provisional application No. 60/893,872, filed on Mar. 8, 2007.

(51) Int. Cl. H04J 14/02

(52) U.S. Cl. 398/87

(57) ABSTRACT

An optical device that processes a wavelength divisional multiplexed (WDM) optical signal includes an arrayed waveguide grating (AWG) and a polarizing liquid crystal array. The AWG demultiplexes and/or multiplexes the wavelength channels of the WDM signal. The liquid crystal array modulates the polarization state of individual wavelength channels so that each wavelength channel may be routed along an optical path based on the polarization state of the light.

### CROSS-REFERENCE TO RELATED APPLICATIONS

This application claims the benefit of U.S. Provisional Patent Application Ser. No. 60/893,872, filed Mar. 8, 2007, entitled “Wavelength Selective Liquid Crystal Switch,” the entire contents of which are incorporated by reference herein.

### BACKGROUND OF THE INVENTION

1. Field of the Invention

Embodiments of the present invention relate generally to optical communication systems and components and, more particularly, to liquid crystal-based optical devices with arrayed waveguide grating.

2. Description of the Related Art

In a wavelength division multiplexing (WDM) optical communication system, information is carried by multiple channels, each channel having a unique wavelength. WDM allows transmission of data from different sources over the same fiber optic link simultaneously, since each data source is assigned a dedicated channel. The result is an optical communication link with an aggregate bandwidth that increases with the number of wavelengths, or channels, incorporated into the WDM signal. In this way, WDM technology maximizes the use of an available fiber optic infrastructure; what would normally require multiple optic links or fibers instead requires only one.

In WDM optical communication systems, it is often necessary to add, drop, or attenuate a light beam. This can be achieved by an optical switching device, which directs an input light beam to one of multiple output optical paths. For example, in a 1 by 2 optical switching device, an input light beam enters through an input fiber and is directed to one of two output fibers. There are also more complicated optical switching devices, such as 2 by 2, 1 by N, and N by N switching device, which are realized by combining several 1 by 2 devices. In some optical networks, the individual wavelength channels of a WDM input signal are directed to different output fibers by an optical switching device, also known as a wavelength router. Different types of wavelength routers known in the art include wavelength selective switches (WSSs) optical add-drop multiplexers (OADMs), and dynamic gain equalizers (DGEs).

WDM wavelength routers commonly include multiple free-space optical components. Free-space optical components, i.e., lenses, mirrors, etc., that are optically coupled by regions of vacuum or atmospheric pressure, must be manufactured and aligned to high tolerances for proper operation of such wavelength routers. Because of this, the manufacturing costs for assembly, testing, and quality assurance of WDM routers is substantial. One such free-space optical component is the diffraction grating, which is used in WDM wavelength routers to multiplex and demultiplex a WDM signal.

Diffraction gratings, such as ruled and holographic gratings, demultiplex the wavelength channels of an incident WDM optical signal by spatially separating the polychromatic WDM signal into its constituent wavelength components, or channels. Similarly, diffraction gratings may also multiplex a plurality of incident wavelength channels into a single polychromatic, or WDM beam. A drawback to the use of diffraction gratings as multiplexers or demultiplexers in WDM routers is the high sensitivity of diffraction grating performance to proper alignment with other optical components. First, alignment of free space optical components to high tolerances is difficult and time consuming. Second, the most precise alignment of a diffraction grating is not too stable because small fluctuations in position and orientation of a diffraction grating caused by thermal expansion of grating elements may be large enough to affect the performance of a WDM wavelength router. Lastly, narrower channel spacing caused by higher bandwidth requirements for recent optical communication networks generally increases diffraction grating sensitivity to alignment issues.

Accordingly, there is a need in the art for lower cost, higher precision and more reliable WDM wavelength routers.

### SUMMARY OF THE INVENTION

Embodiments of the invention provide an optical device that processes a WDM optical signal, and includes an arrayed waveguide grating (AWG) and a polarizing liquid crystal array. The AWG demultiplexes and/or multiplexes the wavelength channels of the WDM signal. The liquid crystal array modulates the polarization state of individual wavelength channels so that each wavelength channel may be routed along an optical path based on the polarization state of the light.

In one embodiment, an optical device for receiving a light beam through an input port and selectively directing the light beam to an output port, and having at least one input port and at least one output port comprises a liquid crystal switch and an AWG. The AWG is positioned in a first optical path of the light beam between the input port and the liquid crystal switch and in a second optical path of the light beam between the liquid crystal switch and the output port. The AWG may be configured to separate the light beam into its wavelength components before the light beam arrives at the liquid crystal switch and/or recombine the wavelength components of the light beam before the light beam arrives at the output port.

In another embodiment, an optical device for receiving an input WDM signal and outputting an output WDM signal comprises an AWG for separating an input WDM signal into its wavelength components and a liquid crystal switch for directing each of the wavelength components into at least one of multiple optical paths.

In another embodiment, a wavelength selective switch comprises at least one input port, at least two output ports, and at least two loss ports, a reflecting unit optically coupled to the input port and optically coupled to the output and loss ports, a liquid crystal switch disposed in a first optical path between the input port and the reflecting unit and a second optical path between the reflecting unit and the output and loss ports, and an AWG disposed in the first optical path between the input port and the liquid crystal switch and in the second optical path between the liquid crystal switch and the output and loss ports.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of an arrayed waveguide chip that may be incorporated into liquid crystal-based optical switching devices according to embodiments of the invention.

FIG. 2A illustrates a schematic plan view of a liquid crystal-based equalizing wavelength router using an arrayed waveguide chip as a multiplexer and demultiplexer, in accordance with one embodiment of the invention.

FIG. 2B shows a partial side view of the wavelength router of FIG. 2A.

FIG. 3 is a perspective view of a wavelength selective switch using an arrayed waveguide chip as a multiplexer and demultiplexer, according to an embodiment of the invention.

For clarity, identical reference numerals have been used, where applicable, to designate identical elements that are common between figures. It is contemplated that features of one embodiment may be incorporated in other embodiments without further recitation.

### DETAILED DESCRIPTION

Embodiments of the invention provide liquid crystal (LC) based WDM wavelength routers that use an arrayed waveguide grating (AWG) to multiplex and demultiplex the wavelength channels of the WDM signal. Such WDM wavelength routers can provide higher reliability at a lower cost than wavelength routers that rely on diffraction gratings for multiplexing and demultiplexing WDM signals.

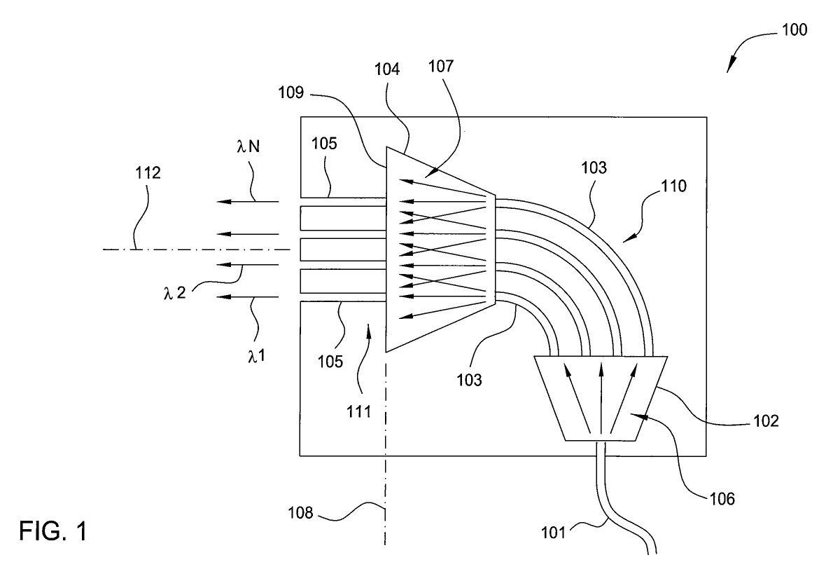

FIG. 1 is a schematic diagram of an AWG chip 100 that may be incorporated into LC-based optical switching devices according to embodiments of the invention. As shown, AWG chip 100 is coupled to an input waveguide 101 and includes a first free space region 102, also referred to as an input coupler, and a second free space region 104, also referred to as an output coupler, each coupled to an array 110 of waveguides 103. An array 111 of output waveguides 105 is coupled to second free space region 104 opposite waveguides 103. Input waveguide 101 is an optical waveguide, such as an optic fiber used in optical communications systems. Waveguides 103 and output waveguides 105 are planar lightwave circuits, and, when AWG chip 100 is a silica-based device, may be fabricated by depositing doped and undoped layers of silica on a silicon substrate using methods commonly known in the art. Each of the plurality of waveguides 103 has a different length, and the difference in length between any two adjacent waveguides 103 is constant across array 110. The length of waveguides 103 is chosen so that the optical path length difference between adjacent waveguide 103 equals an integer multiple of the central wavelength of AWG chip 100.

In operation, a WDM optical signal is introduced via input waveguide 101 into first free space region 102, and diffracts into diffracted beams 106 upon passing through the aperture of input waveguide 101. Diffracted beams 106 travel through first free space region 102 and are optically coupled to waveguides 103. As diffracted beams 106 travel through waveguides 103, each wavelength of light coupled to a particular waveguide 103 undergoes a different phase shift based on the length of that waveguide 103. Due to the constant path length difference between adjacent array waveguides, this phase shift increases linearly from the inner, i.e., shorter, waveguides 103 to the outer, i.e., longer, waveguides 103 of array 110. Diffracted light beams 107 emanate from each waveguide of array 110 into second free space region 104, and, with an appropriately selected phase shift between each of waveguides 103, constructively interfere at an image plane 108. This constructive interference produces light of a single wavelength at discrete points along image plane 108, similar to the diffraction pattern produced by a diffraction grating. The resultant spatial position of each wavelength of light on image plane 108 is determined by the phase shift of array 110. The output face 109 of second free space region 104 is positioned coincident with image plane 108, and output waveguides 105 are spaced to correspond with the constructive interference pattern produced by diffracted light beams 107. In this way, a light beam of essentially one wavelength is coupled to each output waveguide 105, where each beam corresponds to a wavelength channel of the WDM optical signal that is input via input waveguide 101. Conversely, AWG chip 100 can multiplex a plurality of wavelength channels that enter second free space region 104 via array 111 into a single WDM beam that exits through waveguide 101.

The spatial separation and orientation of each wavelength channel of the WDM optical signal may be precisely controlled by the configuration of output waveguides 105. In the example shown in FIG. 1, N wavelength channels, i.e., wavelength channels λ1-λN, are directed from AWG chip 100 by array 111 along optical paths parallel to and centered about an optical axis 112. Optical axis 112 may correspond to an optical axis of an external system optically coupled to AWG chip 100, such as an optical output fiber or a free space optical element. Other configurations of AWG chip 100 are also contemplated. For example, wavelength channels λ1-λN may be directed from AWG chip 100 by array 111 along divergent optical paths, to spatially separate the wavelength channels wider than is practicable by a silicon-based AWG chip.

Using an AWG chip, such as AWG chip 100, as a multiplexer and/or demultiplexer in an LC-based WDM wavelength router has a number of advantages over using a diffraction grating. Because the fabrication of AWG chips is based on standardized photolithographic techniques, AWG chip may be manufactured repeatably in large quantities, to high tolerances, and at relatively low cost compared to gratings. In addition, AWG chips are very compact, may provide a large number of channel numbers with precisely controlled channel spacing, and do not require the extended free space and additional collimating optics for diffraction gratings. Further, AWG chips allow accurate and precise alignment between an input signal of multiple wavelengths and multiple output signals and precise orientation and spatial separation of the individual output signals. Since AWG chips are manufactured from silicon, AWG chips are also significantly less prone to thermally induced misalignment than diffraction gratings.

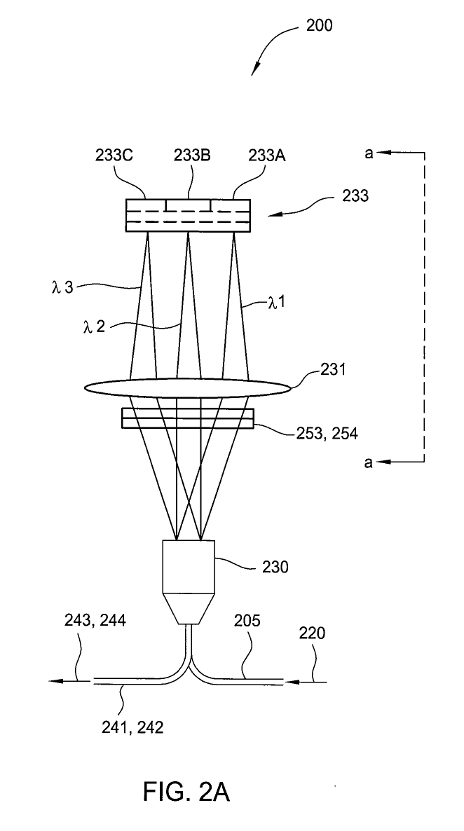

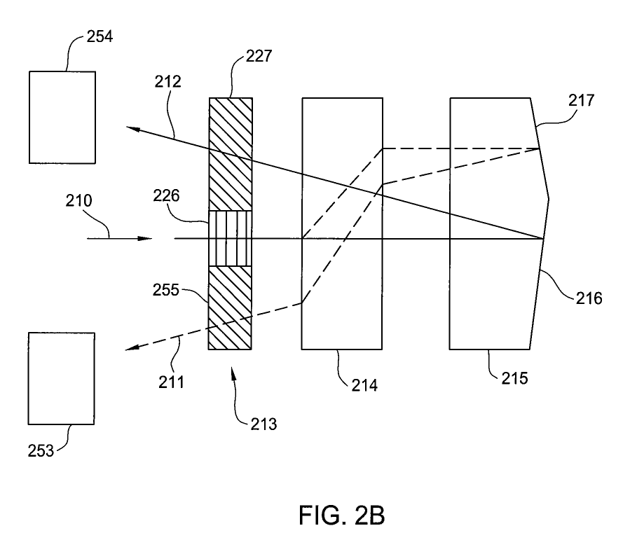

FIG. 2A illustrates a schematic plan view of an LC-based equalizing wavelength router using an AWG chip as a multiplexer and demultiplexer, in accordance with one embodiment of the invention. Router 200 includes an input waveguide 205, an AWG chip 230, a lens 231, an array 233 of LC-based polarization steering devices 233A-C, and absorptive polarizers 253, 254. Absorptive polarizers 253, 254 are designed to transmit light of a single polarization, and to absorb or reflect all other incident light. One example of an absorptive polarizer is a wire-grid polarizer.

Input waveguide 205 optically couples a WDM input beam 220 to AWG chip 230. WDM input beam 220 is spatially separated into wavelength channels λ1-λ3 by AWG chip 230, which are optically coupled to lens 231. Absorptive polarizers 253, 254 are located below and above the plane of wavelength channels λ1-λ3, respectively. The relative vertical positions of wavelength channels λ1-λ3, output beams 221, 222, and absorptive polarizers 253, 254 are described below in conjunction with FIG. 2B. Lens 231 then focuses wavelength channels λ1-λ3 onto polarization steering devices 233A-C, respectively, of array 233. Each of polarization steering devices 233A-C is a separate, independently controlled element of array 233, and is configured to steer and/or attenuate a light beam incident thereon. Steering of light beams consists of rotating the polarization of incident light either 0° or 90°, and then directing the light along either of two optical paths based on the resultant polarization of the light. Attenuation of light beams consists of further modulating the polarization of the redirected light. AWG chip 230 is shown to separate input beam 220 into three wavelength channels λ1-λ3. However, in practice, the number of optical channels contained in input beam 220 and of the corresponding polarization steering devices of array 233 may be up to 50 or more.

FIG. 2B shows a partial side view of router 200, taken from view a-a as indicated in FIG. 2A. For simplicity, the organization and operation of polarization steering device 233A and the interaction thereof with wavelength channel λ1 is described. It is understood that steering devices 233B, 233C operate substantially the same as polarization steering device 233A and interact in a similar fashion with wavelength channels λ2, λ3, respectively. Lens 231 is omitted from FIG. 2B for clarity.

Polarization steering device 233A includes a polarization modulator 213, a birefringent polarization beam displacer 214, and an angled reflector 215. In the example illustrated in FIG. 2B, polarization modulator 213 consists of three independently controlled LC pixels 225, 226, and 227. Birefringent polarization beam displacer 214 is a planar parallel uni-axial crystal plate with its optical axis parallel to the page as viewed in FIG. 2B. Angled reflector 215 consists of two reflective surfaces 216 and 217. Incident beam 210 and output beams 221, 222 as shown in FIG. 2B, correspond to wavelength channel λ1 of FIG. 2A.

In operation, incident beam 210 passes through LC pixel 226 of polarization modulator 213 and is either s- or p-polarized, depending on the molecular orientation of the LC material contained in LC pixel 226. If incident beam 210 is s-polarized by LC pixel 226, the beam is not displaced by beam displacer 214 and is reflected by surface 216, forming output beam 212. Polarization steering device 233A is configured so that output beam 212 is directed through LC pixel 227, which may modulate the polarization of output beam 212 as necessary for the beam to be attenuated by absorptive polarizer 254. Alternatively, if incident beam 210 is p-polarized by LC pixel 226, the beam is displaced by birefringent polarization beam displacer 214, as shown in FIG. 2B, and is reflected by surface 217. The output beam 211 thus produced is directed along a significantly different optical path from output beam 212 and passes through LC pixel 225. LC pixel 225 modulates the polarization of output beam 211 as necessary for the beam to be attenuated by absorptive polarizer 253. After passing through either absorptive polarizers 253 or 254, wavelength channel λ1 is combined, or multiplexed, with other wavelength channels, e.g., λ2 and/or λ3, by AWG chip 230 to form an upper output beam 243 or a lower output beam 244, wherein the upper output beam 243 is optically coupled to a first output waveguide 241 and the lower output beam 244 is optically coupled to a second output waveguide 242. First output waveguide 241, second output waveguide 242, lower output beam 243, and upper output beam 244 are shown in FIG. 2A. Hence, router 200 may selectively direct each wavelength channel contained in input beam 220 to one of two output waveguides, and, in addition, may attenuate any of the wavelength channels λ1-λ3 as desired. An equalizing wavelength router is described in additional detail in commonly assigned U.S. Patent Application Publication No. 2004/0008932, which is hereby incorporated by reference in its entirety.

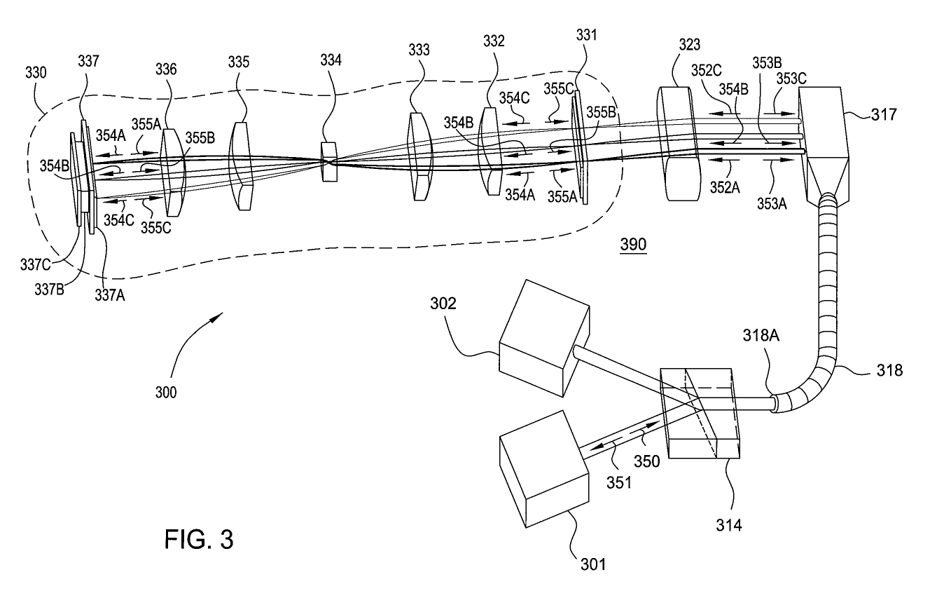

FIG. 3 is a perspective view of a wavelength selective switch (WSS) using an AWG chip as a multiplexer and demultiplexer, according to an embodiment of the invention. In the configuration shown, WSS 300 is a 1×4 WSS and includes an optical input/output port array 301, an optical loss port array 302, a beam steering unit 314, an optical waveguide 318, an AWG chip 317, a focusing lens 323, and a switching optics assembly 330. The components of WSS 300 are mounted on a planar surface 390 that is herein defined as the horizontal plane for purposes of description. In this configuration, WSS 300 performs wavelength separation in the horizontal plane and switching selection in the vertical plane.

For illustrative purposes, inbound light beams 350, 352A-C, 354A-C and outbound light beams 351, 353A-C, 355A-C are shown in FIG. 3 in free space to more clearly indicate the optical coupling of various elements of WSS 300. Because of the bi-directional nature of most components of WSS 300, light beams are directed along parallel inbound and outbound paths simultaneously between optical components of WSS 300. The free space inbound and outbound paths are displaced from each other vertically, and this vertical displacement is further described below. For clarity, a single light beam is used in FIG. 3 to schematically represent both an inbound and outbound light beam between two optical components of WSS 300 rather than two beams that are vertically displaced with respect to one another. For example, inbound light beam 350 and outbound light beam 351 are schematically represented by a single light beam between beam steering unit 314 and optical waveguide 318.

Optical input/output port array 301 optically couples a WDM optical input signal to WSS 300 and includes an optical input port and, in the embodiment described herein, four vertically aligned optical output ports. Optical output array 302 includes four vertically aligned loss ports. The optical output ports act as the optical output interface between WSS 300 and other components of a WDM optical communication system. The loss ports serve as termination points for light beams consisting of unwanted optical energy, for example wavelength channels blocked from a WDM output signal.

Beam steering unit 314 is configured to direct outbound beam 351 along two different optical paths depending on the polarization state of outbound beam 351. The two paths may be separated in the horizontal plane by an angular or translational offset. In the configuration of WSS 300 described herein, beam steering unit 314 directs outbound beam 351 to either of two horizontally displaced points: (1) a horizontal point corresponding to the horizontal position of optical output ports in optical input/output port array 301 or (2) a horizontal point corresponding to the horizontal position of optical loss port array 302. Beam steering unit 314 is shown as a Wollaston prism, which angularly deflects light beams at different angles depending on their orthogonal polarization states. Alternatively, beam steering unit 314 may be a birefringent crystal, such as a YVO₄ crystal, which translationally deflects the light beams by different amounts, depending on their orthogonal polarization states. As for inbound beam 350, beam steering unit 314 directs inbound beam 350 along a single known path to the fiber lens 318A of optical waveguide 318.

Optical waveguide 318 optically couples beam steering unit 314 and AWG chip 317, and may be an optical fiber. AWG chip 317 is similar in configuration and operation to AWG chip 100, described above in conjunction with FIG. 1, where optical waveguide 318 acts as input waveguide 101, and wavelength channels λ1-λN are represented by inbound beams 352A-C. AWG chip 317 is configured to spatially separate, or demultiplex, each wavelength channel of inbound beam 350 by directing each wavelength along a unique optical path. In so doing, diffraction grating 317 forms a plurality of inbound beams 352A-C, where the number of inbound beams corresponds to the number of optical wavelength channels contained in inbound beam 350. In FIG. 3, AWG chip 317 is shown to separate inbound beam 350 into three inbound beams 352A-C. However, in practice, the number of optical channels contained in inbound beam 350 may be up to 50 or more. AWG chip 317 separates the wavelength channels horizontally, as depicted in FIG. 3, and directs inbound beams 352A-C through focusing lens 323. AWG chip 317 also performs wavelength combination, or multiplexing, of outbound beams 353A-C into outbound beam 351.

Focusing lens 323 optically couples AWG chip 317 with switching optics assembly 330 by focusing inbound beams 352A-C on the first element of switching optics assembly 330, i.e., beam polarization unit 331.

Switching optics assembly 330 includes an LC-based beam polarization unit 331, collimating lenses 332, 333, a beam steering unit 334, collimating lenses 335, 336, and an LC-based beam polarization and steering unit 337. The elements of switching optics assembly 330 are optically linked to enable the optical routing of a WDM optical input signal originating from the input port of optical input/output port assembly 301 to any one of the optical output ports of optical input/output port assembly 301 or to optical loss port array 302. The optical routing is performed by conditioning (via LC polarization) and vertically displacing inbound beams 352A-C to produce outbound beams 353A-C.

Switching optics assembly 330 selectively determines the vertical displacement of outbound beams 353A-C to correspond to the vertical position of the desired output port of optical input/output port assembly 301, hence performing a 1×4 optical switching operation. In addition, switching optics assembly 330 may selectively condition each of inbound beams 352A-C to allow independent attenuation or blocking thereof. Further, switching optics assembly 330 performs the 1×4 switching operation with a high extinction ratio. Lastly, switching optics assembly 330 allows switching of outbound beam 351 between optical output ports to be “hitless,” i.e., without the transmission of a signal to unwanted output ports, such as inactive output ports.

Beam polarization unit 331 includes an LC switching array and an array of transparent electrodes, which together are configured to condition the polarization of each of inbound beams 352A-C and produce inbound beams 354A-C. The LC switching array and the array of transparent electrodes are also configured to condition the polarization state of outbound beams 355A-C so that each beam, and therefore each wavelength channel of outbound beam 351, may be independently attenuated or directed to one of the loss ports of 302. By modulating the polarization of each of outbound beams 355A-C prior to multiplexing, the desired portion of each beam, i.e., each wavelength channel of outbound beam 351, may be selectively directed by beam steering unit 314 to a loss port of optical loss port array 302 or to an output port of optical input/output port array 301. The electrodes are arranged vertically and horizontally to define individual LC pixels, the pixels being optically coupled to inbound or outbound beams.

Beam steering unit 334 is configured to direct inbound beams 354A-C along two different optical paths, i.e., an upper and a lower path, depending on the polarization state of the beams. Hence, beam steering unit 334 operates in a similar manner to birefringent beam steering unit 314, except that beam steering unit 334 is oriented to produce a vertical displacement between two possible optical paths rather than a horizontal displacement. As noted above, the polarization state of inbound beams 354A-C is determined by the polarization conditioning performed by beam polarization unit 331. The two optical paths are separated angularly or by a translational offset in the vertical direction. In either case, the vertical offset between the two possible paths for inbound beams 354A-C indicates that inbound beams 354A-C may be directed to either an upper or lower region of beam polarization and steering unit 337. Beam steering unit 334 is also configured to direct outbound beams 355A-C back through beam polarization unit 331.

Similar to beam polarization unit 331, beam polarization and steering unit 337 includes an LC array and a plurality of transparent control electrodes. Beam polarization and steering unit 337 further includes a birefringent crystal 337B (e.g., a YVO₄ crystal) and a reflective element 337C (e.g., a mirror). Beam polarization and steering unit 337 is configured to direct each incident beam, i.e., inbound beams 354A-C, along two different parallel optical paths, separated by a vertical offset, depending on the polarization conditioning by LC array 337A. Since each of inbound beams 354A-C may be directed to beam polarization and steering unit 337 along two possible sets of optical paths from beam steering unit 334, i.e., an upper path or lower path, outbound beams 355A-C may be directed from beam polarization and steering unit 337 along any of four vertically displaced optical path sets.

By using an AWG chip as a multiplexer and demultiplexer, WSS 300 has a more simple and compact architecture compared to a WSS using one or more diffraction gratings. WSS 300 is also less prone to optical alignment issues caused by inaccurate set-up or thermal expansion. Further, WSS 300 may be more easily configured to process WDM signals with narrower channel spacings than diffraction grating-based WSSs.

While the foregoing is directed to embodiments of the present invention, other and further embodiments of the invention may be devised without departing from the basic scope thereof, and the scope thereof is determined by the claims that follow.

What is claimed is:

1. An optical device having at least one input port and at least one output port, for receiving a light beam through an input port and selectively directing the light beam to an output port, comprising:
a liquid crystal switch; and
an arrayed waveguide grating positioned in a first optical path of the light beam between the input port and the liquid crystal switch and in a second optical path of the light beam between the liquid crystal switch and the output port.

2. The optical device according to claim 1, wherein the arrayed waveguide grating is configured to separate the light beam into its wavelength components before the light beam arrives at the liquid crystal switch.

3. The optical device according to claim 2, wherein the arrayed waveguide grating is configured to recombine the wavelength components of the light beam before the light beam arrives at the output port.

4. The optical device according to claim 1, wherein the arrayed waveguide grating comprises an input waveguide optically coupled to the input port and an array of output waveguides optically coupled to the liquid crystal switch.

5. The optical device according to claim 4, wherein the arrayed waveguide grating further comprises a plurality of intermediate waveguides of different optical lengths arranged between the input waveguide and the array of output waveguides.

6. The optical device according to claim 5, wherein the difference in length between any two adjacent intermediate waveguides is the same.

7. The optical device according to claim 5, wherein the arrayed waveguide grating is a silica-based device.

8. An optical device for receiving an input wavelength division multiplexing (WDM) signal and outputting an output WDM signal, comprising:
an arrayed waveguide grating for separating an input WDM signal into its wavelength components; and
a liquid crystal switch for directing each of the wavelength components into at least one of multiple optical paths.

9. The optical device according to claim 8, wherein the arrayed waveguide grating is arranged to recombine the wavelength components into an output WDM signal.

10. The optical device according to claim 9, wherein the liquid crystal switch comprises a reflective element that optically couples the wavelength components that are directed by the liquid crystal switch to the arrayed waveguide grating.

11. The optical device according to claim 8, wherein the liquid crystal switch includes:
first and second liquid crystal beam polarizing units;
a first beam steering unit disposed in an optical path between the first and second liquid crystal beam polarizing units, for directing a light beam in accordance with a polarization state of the light beam; and
a second beam steering unit, disposed downstream of the second liquid crystal beam polarizing unit, for directing a light beam in accordance with a polarization state of the light beam.

12. The optical switch according to claim 11, wherein the first beam steering unit comprises a Wollaston prism.

13. The optical switch according to claim 12, wherein the second beam steering unit comprises a birefringent crystal.

14. The optical device according to claim 8, wherein the liquid crystal switch includes:
a liquid crystal beam polarizing unit;
a beam steering unit for directing a light beam in accordance with a polarization state of the light beam; and
a reflective element for optically coupling the light beam from the beam steering unit with the liquid crystal beam polarizing unit.

15. The optical device according to claim 14, further comprising an absorptive polarizer positioned in the optical path of the light beam after the light beam has been reflected by the reflective element and passed through the liquid crystal beam polarizing unit.

16. A wavelength selective switch comprising:
at least one input port, at least two output ports, and at least two loss ports;
a reflecting unit optically coupled to the input port and optically coupled to the output and loss ports;
a liquid crystal switch disposed in a first optical path between the input port and the reflecting unit and a second optical path between the reflecting unit and the output and loss ports; and
an arrayed waveguide grating disposed in the first optical path between the input port and the liquid crystal switch and in the second optical path between the liquid crystal switch and the output and loss ports.

17. The wavelength selective switch according to claim 16, wherein the arrayed waveguide grating is a silica-based device.

18. The wavelength selective switch according to claim 16, wherein the arrayed waveguide grating comprises an input waveguide optically coupled to the input port and an array of output waveguides optically coupled to the liquid crystal switch.

19. The wavelength selective switch according to claim 18, wherein the arrayed waveguide grating further comprises a plurality of intermediate waveguides of different optical lengths arranged between the input waveguide and the array of output waveguides.

20. The wavelength selective switch according to claim 19, wherein the difference in length between any two adjacent intermediate waveguides is the same.
